(19) United States
(12) Patent Application Publication
(10) Pub. No.: US 2009/0101565 A1
(43) Pub. Date: Apr. 23, 2009

(54) Water-Cleaner

(76) Inventor: Chiang-Pei Chen, Taiping City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/342,324

(22) Filed: Dec. 23, 2008

Related U.S. Application Data
(63) Continuation-in-part of application No. 11/456,649, filed on Jul. 11, 2006.

(51) Int. Cl. B01D 35/30

(52) U.S. Cl. 210/245

(57) ABSTRACT

A portable direct current water-cleaner includes a handheld tank for storing a water chamber and a component chamber entirely therein. The water chamber is adapted for containing water and the component chamber for receiving a pump adapted for pumping the water, a filter adapted for filtering the water and a switch valve installed in the tank. The switch valve is operable between a first mode for directing the water from the pump to the filter so that the water passes through the filter and a second mode for bypassing the filter.

### CROSS REFERENCE TO RELATED PATENT APPLICATION

This application is a continuation-in-part application of application Ser. No. 11/456,649, filed Jul. 11, 2006, the contents of which are incorporated herein by reference.

### BACKGROUND OF THE INVENTION

1. Field of the Invention

The present invention relates to a direct current water-cleaner and, more particularly, to a handheld-type-tank water-cleaner for being carried on with a user easily.

2. Description of the Related Art

Disclosed in Taiwanese Patent Publication No. 564769 is a portable bottle-type water-filtering apparatus. The apparatus includes a bottle 50, a cap 10 and a filter 20. The bottle 50 is formed with a bottleneck 51. The cap 10 includes a tube 12 and a socket 14. The tube 12 includes a first section extended from a outer surface of the cap 10 and a second section extended from a inner surface of the cap 10. The socket 14 is formed on the inner surface of the cap 10 around the second section of the tube 12. The filter 20 includes a case and a filtering material 21 filled in the case. The case includes a sieve 23 at an end and an opening at an opposite end. A neck 22 is formed on the sieve 23 and fit in the socket 14. A plug 25 is fit in the opening of the case. A plurality of apertures 251 is defined in the plug 25.

The above-mentioned portable bottle-type water-filtering apparatus contains a small amount of water. Therefore, it is not very helpful when it is used during camping in the wilds where water is scarce. A large water-filtering apparatus contains a large amount of water; however, it takes a lot of time for the large water-filtering apparatus to filter water, and this is inconvenient.

The present invention is therefore intended to obviate or at least alleviate the problems encountered in the prior art.

### SUMMARY OF THE INVENTION

According to the present invention, a portable direct current water-cleaner includes a handheld tank for storing a water chamber and a component chamber. The water chamber is adapted for containing water, and the component chamber is adapted for receiving a pump for pumping the water and a filter for filtering the water. A control panel is provided to close the component chamber and switch valve is installed at the control panel toward the interior of the handheld tank. The valve is operable to be switched between a first mode for leading the water from the pump to the filter so that the pump makes the water pass through the filter quickly and a second mode for leading the water bypassing the filter.

It is an advantage of the water-cleaner according to the present invention to store the pump, the filter and the switch valve in the component chamber inside of the handheld tank so that the water-cleaner is easy to carry on with a user.

It is another advantage of the water-cleaner according to the present invention to contain the water inside of the water chamber of the handheld tank so that the user does not need to find a water resource outside, and it can save power to lead the outer water into the filter of the water-cleaner.

It is another advantage of the water-cleaner according to the present invention to clean water quickly for using the pump to pump the water within the handheld tank through the filter.

It is another advantage of the water-cleaner according to the present invention to provide options of whether to clean the water or not.

Other advantages and features of the present invention will become apparent from the following description referring to the drawings.

### BRIEF DESCRIPTION OF THE DRAWINGS

The present invention will be described through detailed illustration of three embodiments referring to the drawings.

FIG. 1 is a perspective view of a water-cleaner according to the first embodiment of the present invention.

FIG. 2 is an exploded view of the water-cleaner shown in FIG. 1.

FIG. 3 is a cross-sectional view of the water-cleaner taken along a line 3-3 in FIG. 1.

FIG. 4 is a rear view of the water-cleaner shown in FIG. 1.

FIG. 5 is a block diagram of the water-cleaner shown in FIG. 1.

FIG. 6 is a cross-sectional view of the water-cleaner in another position than shown in FIG. 3.

FIG. 7 is a rear view of the water-cleaner in another position than shown in FIG. 4.

FIG. 8 is a block diagram of the water-cleaner in another position than shown in FIG. 5.

FIG. 9 is a perspective view of a water-cleaner according to the second embodiment of the present invention.

FIG. 10 is a block diagram of the water-cleaner shown in FIG. 9.

FIG. 11 is a perspective view of a water-cleaner according to the third embodiment of the present invention.

FIG. 12 is a cross-sectional view of the water-cleaner of FIG. 11 switched to a filtering mode.

FIG. 13 is a cross-sectional view of the water-cleaner of FIG. 11 switched to a spraying mode.

FIG. 14 is a perspective view of a car and the water-cleaner of FIG. 13 electrically connected to the car.

FIG. 15 is a perspective view of a water-cleaner according to the fourth embodiment of the present invention.

### DETAILED DESCRIPTION OF THE PREFERRED EMBODIMENT

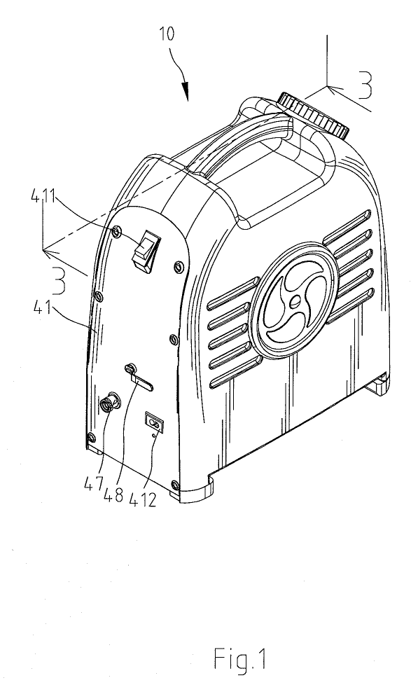

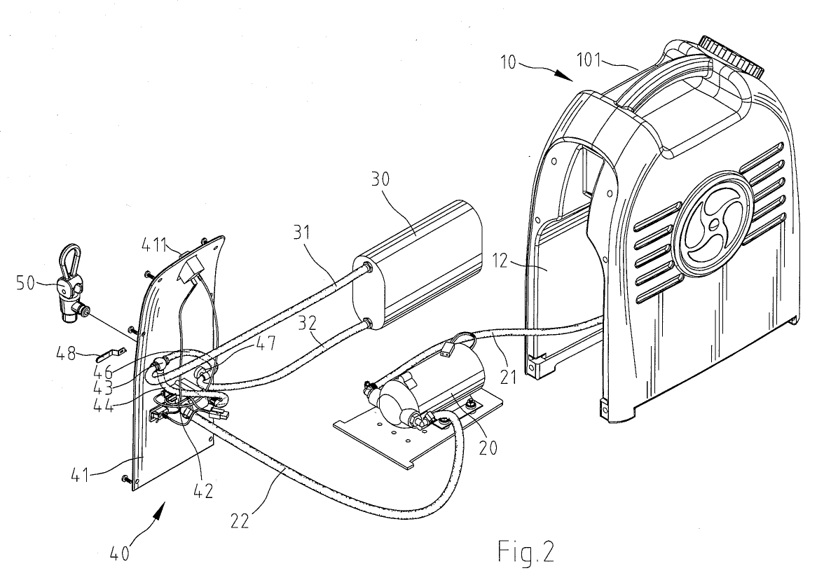

Referring to FIGS. 1 through 3, a portable direct-current (“DC”) water-cleaner according to a first embodiment of the present invention includes a handheld tank 10, a pump 20, a filter 30 and a mode-switching device 40. The pump 20 and the filter 30 are both storied within the handheld tank 10.

The handheld tank 10 which forms a handle 101 on the top thereof includes a water chamber 11 provided therein for containing water and a component chamber 12 provided therein for storing the pump 20, the filter 30. The water and component chambers 11 and 12, which are fulfilled in the interior of the handheld tank 10, are separated from each other via a separating plate 13. Thus, the water chamber 11 is in form of L-shaped storage. The component chamber 12 has an opening (not numbered) opened to a side of the handheld tank 10 and closed by the mode-switching device 40. The component chamber 12 further defines a first section 121 and a second section 122, and the first section 121 extends at an oblique angle from the second section 122.

The pump 20 is located in the second section 122 of the component chamber 12. A first pump pipe 21 is provided to communicate the water chamber 11 with the pump 20 and a second pump pipe 22 is provided to communicate the pump 20 with the mode-switching device 40. Further, the filter 30 is also located in the second section 122 of the component chamber 12. An inlet pipe 31 and an outlet pipe 32 are respectively provided to communicate the filter 30 to the mode-switch device 40.

The mode-switching device 40, which is provided to close the opening of the component chamber 12, includes a control panel 41 installed on the side of the handheld tank 10 and having an outer surface and an inner surface. The inner surface of the control panel 41 is toward the interior of the handheld tank 10 and the outer surface of the control panel 41 is opposite to the inner surface of the control panel 41. A regulator 42 and a switch valve 43 are installed on the inner surface of the control panel 41. An outlet 47 is provided at the inner surface of the control panel 41 and protrudes from the outer surface of the control panel 41. A switch handle 48 is installed at the outer surface of the control panel 41 and coupled to the switch valve 43 for operably switching the switch valve 43 between a first mode and a second mode.

The first pump pipe 21 leads the water stored in the water chamber 10 to the pump 20, and the second pump pipe 22 is adapted to lead the water pressurized by the pump 20 to regulator 42. A first pipe 44 communicates the regulator 42 with the switch valve 43. While the switch valve 43 is operated to the first mode, the water in the switch valve 43 is leaded to the filter 30 via the inlet pipe 31. Then, the filtered water is leaded to the outlet 47 via the outlet pipe 32. On the contrary, while the switch valve is operated to the second mode, the water in the switch valve 43 is directly leaded to the outlet 47 via a second pipe 46 and bypasses the filter 30.

A button 411 is installed on the outer surface of the control panel 41 and electrically connected to the pump 20 for turning on/off the pump 20. A faucet 50 is installed at the outer surface of the control panel 41 and provided to connect to the outlet 47 so that the water that is leaded to the outlet 47 can flow from the faucet 50.

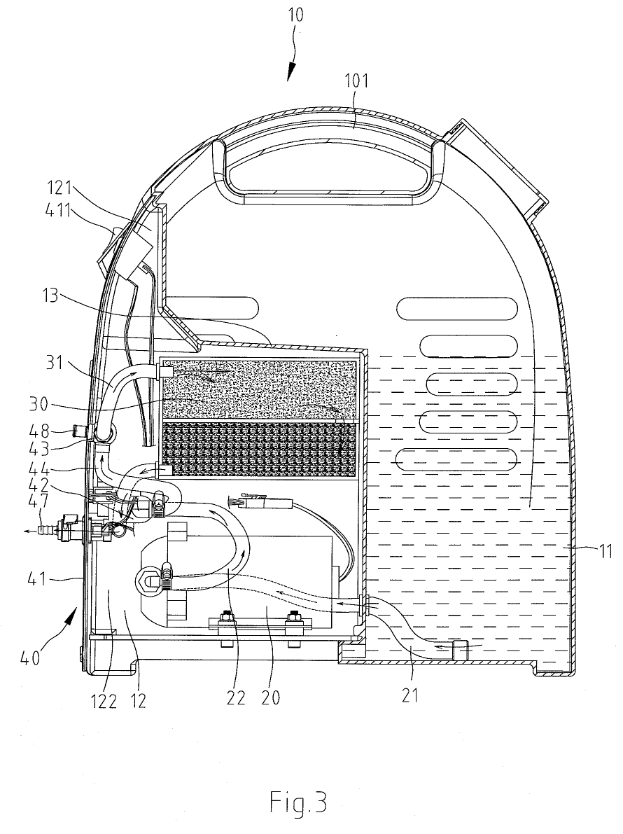

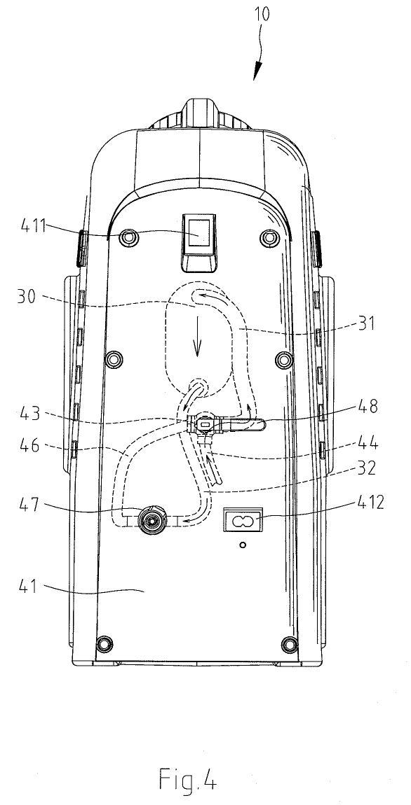

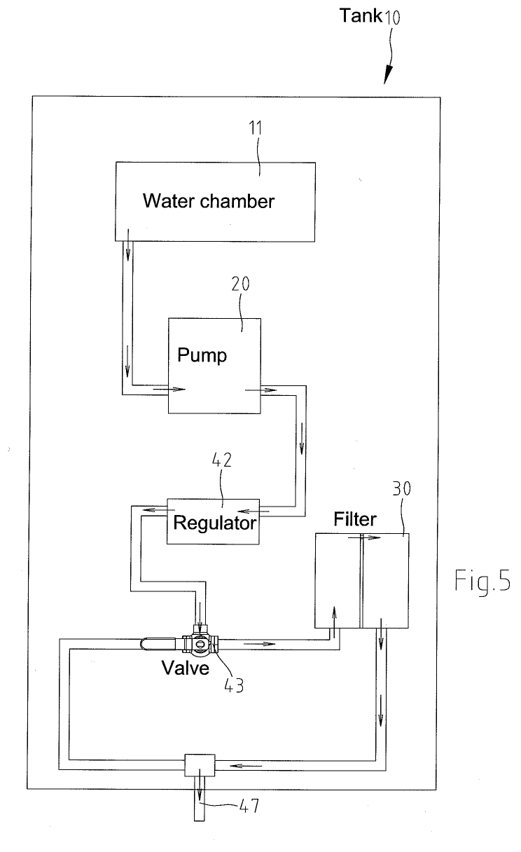

FIGS. 3 through 5 show that the switch valve 43 is operated to the first mode and the water is leaded through the filter 30 and flows from the outlet 47. Water is contained in the water chamber 11 of the handheld tank 10 in advance. The button 411 is operated to turn on the pump 20 to pump the water to the filter 30. The regulator 42 regulates the hydraulic pressure of the water. The switch handle 48 is operated to switch the switch valve 43 to the first mode as shown in FIG. 4. Thus, the water passes through the filter 30 quickly and flows from the outlet element 47. The filter 30 can be employed a reverse-osmosis technique or include active carbon for clearing the water.

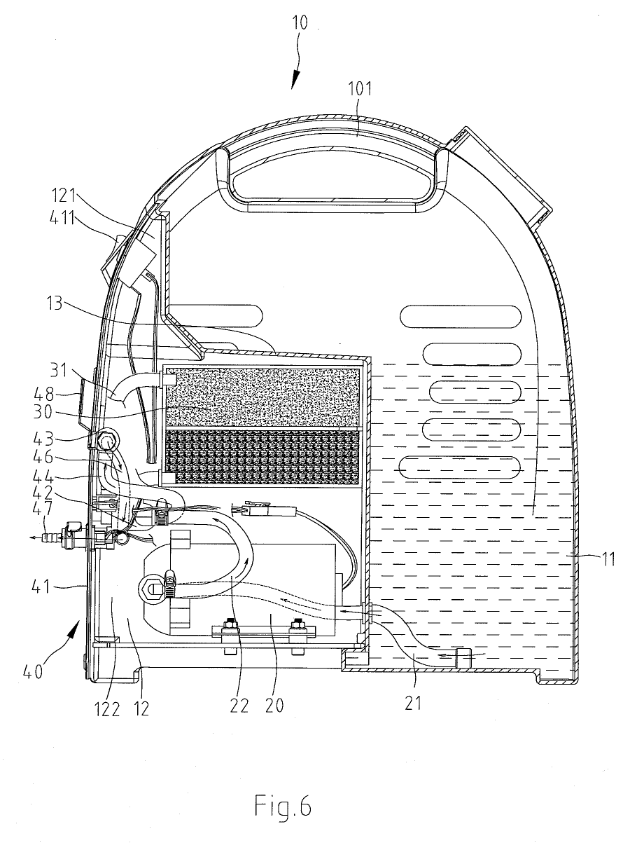

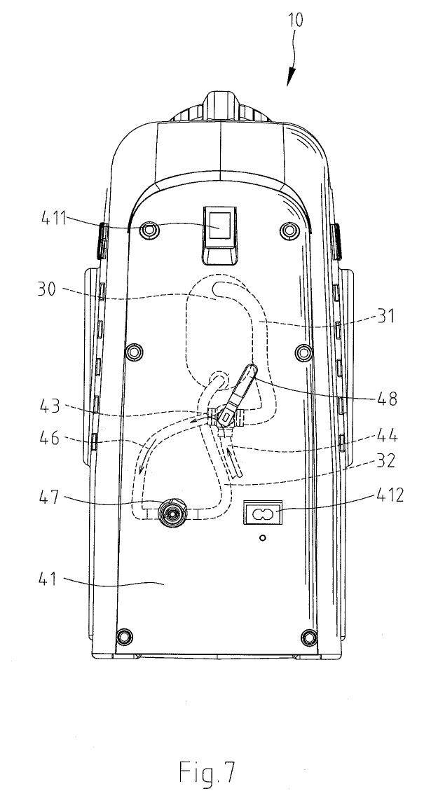

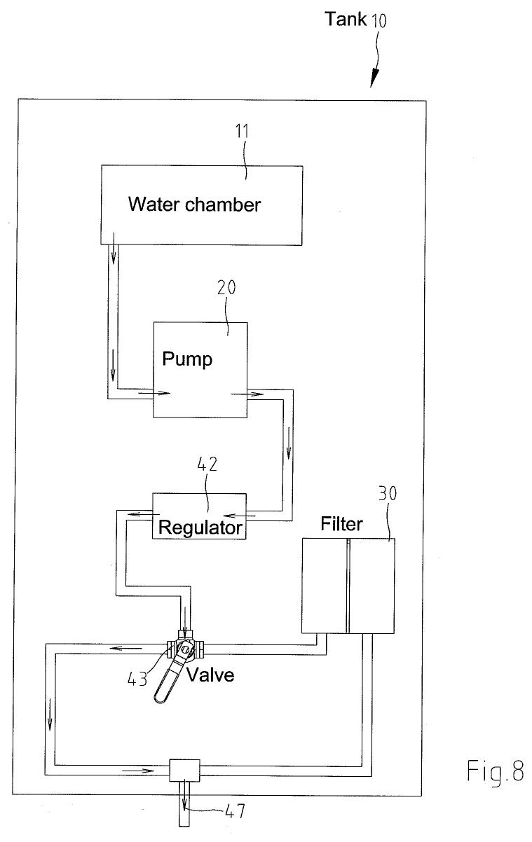

FIGS. 6 through 8 show that the switch valve 43 is operated to the second mode and the water bypasses the filter 30 and directly flows from the outlet 47. The switch 48 is operated to switch the switch valve 43 to the second mode as shown in FIG. 7. Thus, the water passes to the outlet 47 from the valve 43 directly and does not be filtered by the filter 30. Then, the water flows from the outlet 47.

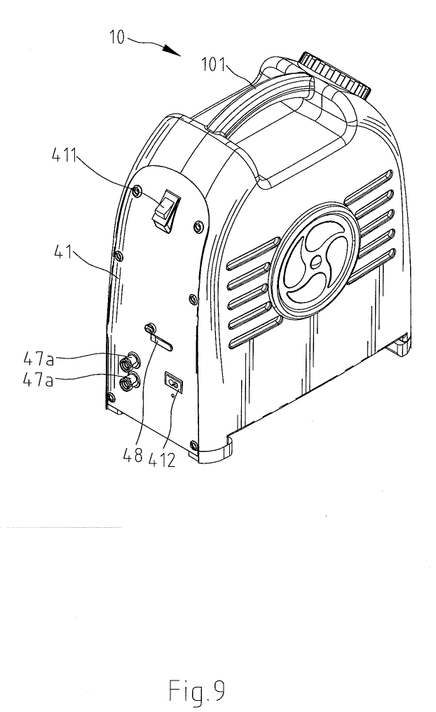

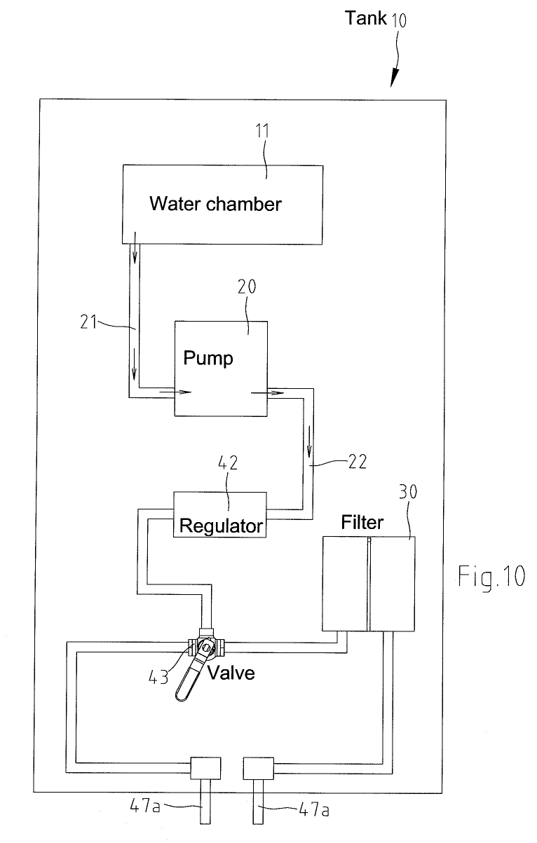

Referring to FIGS. 9 and 10, a portable DC water-cleaner according to a second embodiment of the present invention is similar to the first embodiment except that two outlets 47a replace the outlet 47. One of the outlets 47a is connected to the filter 30 through the pipe 32 while the other outlet 47a is connected to the valve 43 through the pipe 46. Hence, the water which is pumped to pass through the filter 30 in the first mode and the water which is pumped to bypass the filter 30 in the second mode respectively flow from the outlets 47a respectively. It prevents the water that is not filtered from polluting the outlet 47a that provides the filtered water passing through.

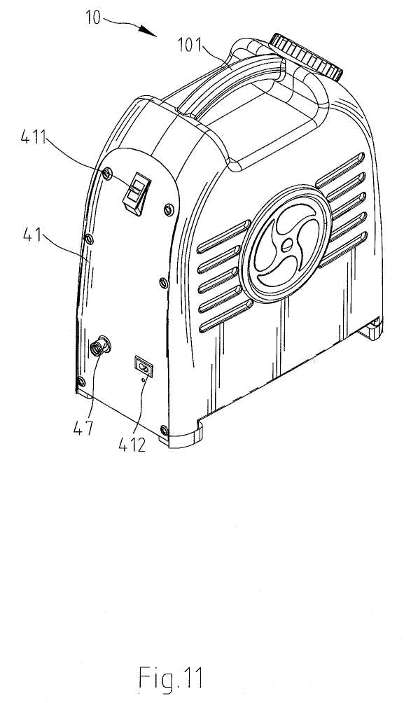

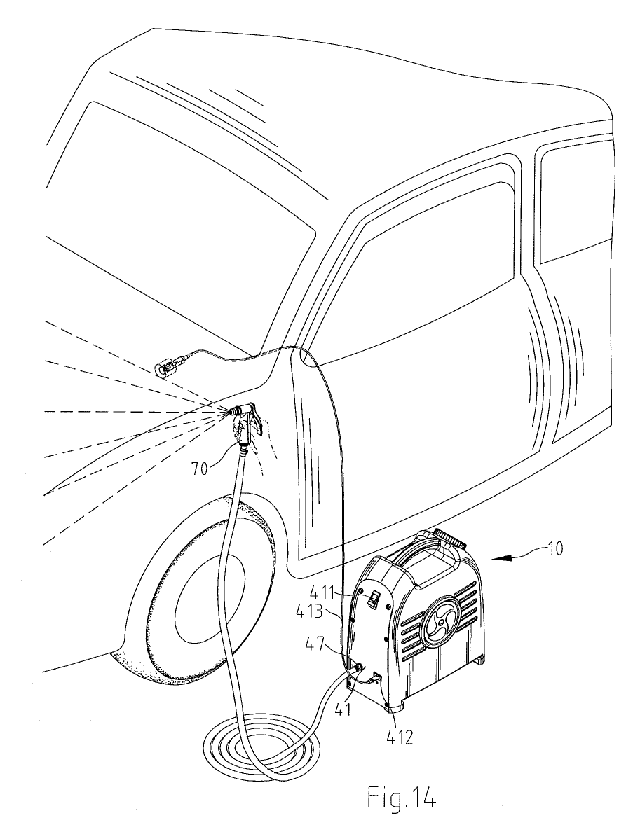

Referring to FIGS. 11 through 14, a portable DC water-cleaner according to a third embodiment of the present invention is similar to the first embodiment except that a socket 412 is installed on the outer surface of the control panel 41 and a wire 413 having a first plug and a second plug. The first plug is defined at a first end of the wire 413 and inserted in a socket (not numbered) connected to a power supply (not numbered) installed in a car (not numbered) while the second plug is inserted in the socket 412. Electricity is transmitted to the portable DC water-cleaner from the power supply through the wire 413.

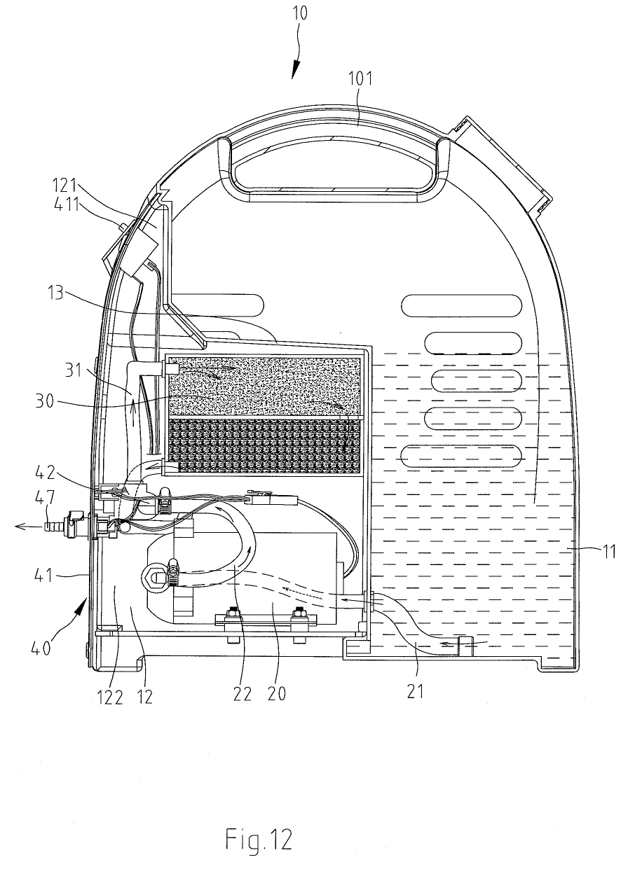

While the switch valve 43 of the portable DC water-cleaner is in the first mode (cleaning mode) as shown in FIG. 12 by operating the switch handle 48 and the pump 20 is turned on via operating the button 411, the pump 20 pumps the water to the filter 30 from the water chamber 11 of the handheld tank 10. The water flows from the filter 30 through the outlet 47.

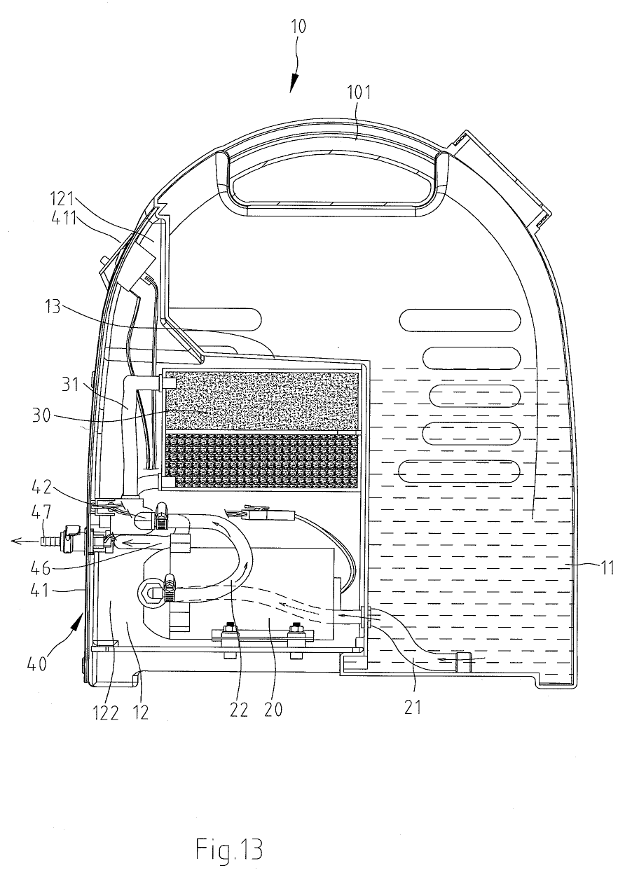

While the switch valve 43 of the portable DC water-cleaner is in the second mode (spraying mode) as shown in FIG. 13 by operating the switch handle 48 and the pump 20 is turned on via operating the button 411, the pump 20 pumps the water to the outlet 47 from the water chamber 11 of the handheld tank 10 through the regulator 42. The water flows from the outlet 47 and bypasses the filter 30.

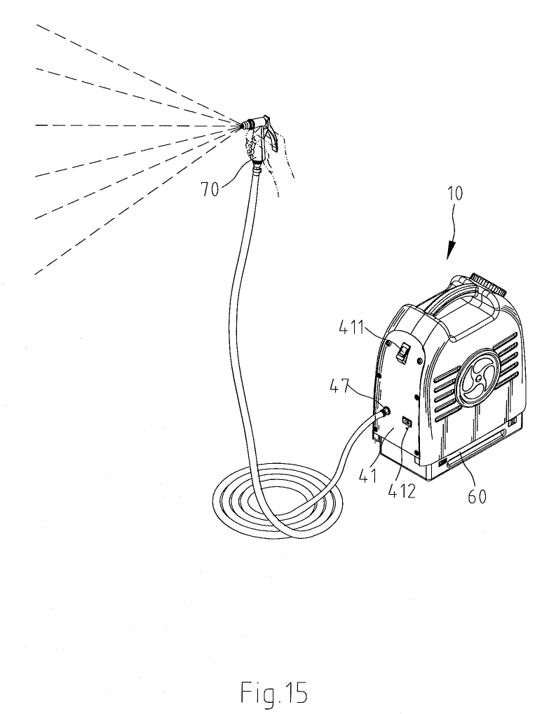

Referring to FIG. 15, a portable DC water-cleaner according to a fourth embodiment of the present invention is similar to the third embodiment except further including a battery 60 adapted for energizing the portable DC water-cleaner and replacing the wire 413 that connects power supply and a nozzle 70 connected to the outlet 47 through a hose (not numbered). So that the water that flows from the outlet 47 can be sprayed from the nozzle 70.

The portable DC water-cleaner according to the present invention exhibits several advantages. Firstly, the handheld tank 10 stores the water chamber and the component chamber entirely therein. So that water can be contained in the handheld tank 10 in advance, and the pump 20, the filter 30, the regulator 42, the switch valve 43 and the pipes connecting components in the component chamber 12 are allowed to be stored in the component chamber 12 of the handheld tank 10. Further, the handle 101 of the handheld tank 10 is adapted for a user to easily carry on the water-cleaner. And it is not needed to find an outer water resource outdoors. In addition, a water-cleaner in accordance with the present invention is suitable to be carried and stored in a trunk of a vehicle. Hence, users can wash the vehicle or a bike by using the water-cleaner as the switch valve 43 in the second mode. Moreover, when users feel thirsty, they can drink the water flowing from the water-cleaner as the switch valve 43 is in the first mode. According to users' needs, it can be chosen to whether the water flowing from the water-cleaner is filtered or not. Secondly, it provides a stable stream of water by using the regulator 42 to regulating the hydraulic pressure of the water. Thirdly, it provides options of whether to filter the water stored in the handheld tank 10 or not.

The present invention has been described through the illustration of the embodiments. Those skilled in the art can derive variations from the embodiments without departing from the scope of the present invention. Hence, the embodiments shall not limit the scope of the present invention defined in the claims.

What is claimed is:

1. A portable direct current water-cleaner comprising:
a handheld tank including a water chamber adapted for containing water and a component chamber, with the water and component chambers separated from each other and entirely located within the handheld tank;
a pump installed in the component chamber of the handheld tank for pumping the water contained in the water chamber;
a filter installed in the component chamber of the handheld tank;
a switch valve installed in the component chamber between the pump and the filter in the handheld tank; and
an outlet element connected to the switch valve and the filter respectively;
wherein when the switch valve is in a first mode, the pumped water is directed to pass through the filter from the water chamber so that the purified water flows to the outlet element;
wherein when the switch valve is in a second mode, the pumped water is directed from the water chamber to bypass the filter so that the water is not filtered by the filter and flows to the outlet element.

2. The portable direct current water-cleaner according to claim 1, further comprising a control panel installed at a side of the handheld tank related to the component chamber and having outer and inner surfaces, with the switch valve installed on the inner surface of the control panel, with the outlet provided at the inner surface of the control panel and protrudes from the outer surface of the control panel.

3. The portable direct current water-cleaner according to claim 2, further comprising a regulator for regulating the hydraulic pressure of the water pumped by the pump, with the regulator installed on the inner surface of the panel, with the regulator connecting to the pump via a second pump, with the regulator connecting to the switch valve via a first pipe.

4. The portable direct current water-cleaner according to claim 1, further comprising a switch handle installed at the outer surface of the control panel and coupled to the switch valve for operably switching the switch valve between the first and second modes.

5. The portable direct current water-cleaner according to claim 1, further comprising a separating plate provided inside of the handheld tank for separating the water and component chambers.

6. The portable direct current water-cleaner according to claim 5, wherein the water chamber is a L-shaped storage and the component chamber has an opening closed by the control panel, with the component chamber defining a first section and a second section, with the first section extending at an oblique angle from the second section.

7. The portable direct current water-cleaner according to claim 6, wherein the pump, the filter and the switch valve are located in the second section of the component chamber.

8. The portable direct current water-cleaner according to claim 2, further comprising a button installed on the outer surface of the control panel and electrically connected to the pump for turning on/off the pump.

9. The portable direct current water-cleaner according to claim 8, further comprising a separating plate provided inside of the handheld tank for separating the water and component chambers.

10. The portable direct current water-cleaner according to claim 9, wherein the water chamber is a L-shaped storage and the component chamber has an opening closed by the control panel, with the component chamber defining a first section and a second section, with the first section extending at an oblique angle from the second section.

11. The portable direct current water-cleaner according to claim 10, wherein the pump and the filter are located in the second section of the component chamber.

12. The portable direct current water-cleaner according to claim 11, with the button located in the first section of the component chamber, with the button controlling activation of the pump, with the filter and the switch valve intermediate the button and the pump.

13. The portable direct current water-cleaner according to claim 1 wherein the filter comprises a reverse-osmosis material.

14. The portable direct current water-cleaner according to claim 1 wherein the filter comprises active carbon.

15. The portable direct current water-cleaner according to claim 1 comprising a battery energizing the pump.

16. The portable direct current water-cleaner according to claim 1 wherein the pump is energized by a power supply of a vehicle.

17. The portable direct current water-cleaner according to claim 1, wherein while the switch valve is operated to the second mode, the water in the switch valve is directly leaded to the outlet via a second pipe and bypasses the filter.

18. The portable direct current water-cleaner according to claim 1, further comprising an inlet pipe and an outlet pipe respectively provided to communicate the filter to the mode-switching device.

19. The portable direct current water-cleaner according to claim 17, further comprising an inlet pipe and an outlet pipe respectively provided to communicate the filter to the mode-switching device.

20. The portable direct current water-cleaner according to claim 19, wherein two outlets are connected to the switch valve and the filter respectively, with one outlet connected to the filter 30 through the outlet pipe, with the other outlet connected to the valve 43 through the pipe.
